(19) United States
(12) Patent Application Publication
(10) Pub. No.: US 2013/0097005 A1
(43) Pub. Date: Apr. 18, 2013

(54) ONLINE TECHNIQUES FOR SELLING GROUP COMBO COUPONS

(71) Applicants: Jie Yang, Santa Clara, CA (US); Liang Zhang, Fremont, CA (US); Belle Tseng, Cupertino, CA (US)

(72) Inventors: Jie Yang, Santa Clara, CA (US); Liang Zhang, Fremont, CA (US); Belle Tseng, Cupertino, CA (US)

(73) Assignee: YAHOO! INC., Sunnyvale, CA (US)

(21) Appl. No.: 13/271,935

(22) Filed: Oct. 12, 2011

(51) Int. Cl. G06Q 30/02

(52) U.S. Cl. 705/14.39; 705/14.1

(57) ABSTRACT

Techniques for providing group discounts are described. A group discount package is configured by associating a plurality of different items with the package, associating a discount price with each item, and associating a threshold value with at least one item. One or more actions that have corresponding threshold values may also be associated with the package. The group discount package may be offered by enabling users to request to purchase items associated with the package. Each user may request to purchase one or more of the items associated with the package at the associated discount price. Furthermore, the users may be enabled to perform any actions associated with the package. A deal with the package is confirmed when each associated threshold value is met.

### BACKGROUND OF THE INVENTION

1. Field of the Invention

The present invention relates to online deals and incentives.

2. Background

For many years, customers have been able to shop for products and services. Traditionally, a customer has been able to purchase a product or service from a merchant. The merchant may occasionally offer discounts on their products and/or services. Such discounts may benefit customers with lower prices, and may benefit merchants by enabling increased sales volumes, enabling excess inventory to be reduced, and providing further benefits. In some cases, a merchant may offer a discount if a group of items is purchased together by a customer. Examples of such group discounts include vacation package deals that include airfare and lodging, kids meals that includes a combination of a hamburger, French fries, and a drink (e.g., a Happy Meal provided by McDonald's Corporation of Oak Brook, Ill.), and further types of group discounts.

In recent years, the Internet has provided a new medium for customers to purchase products and services from merchants. For example, thousands of electronic commerce websites such as amazon.com, provided by Amazon.com, Inc. of Seattle, Wash., and ebay.com, provided by eBay Inc. of San Jose, Calif., have been established that sell products and services over the Internet. The availability of products and services for sale over the Internet has made shopping more convenient for customers and enabled merchants to reach larger numbers of customers.

Some websites have recently been provided online that provide coupons for discounted products and services to groups of users. Examples of such websites include www.groupon.com provided by Groupon, Inc. of Chicago, Ill. and livingsocial.com provided by LivingSocial Inc. of Washington, D.C. Some of these websites provide coupons that are activated if a predetermined minimum number of persons sign up for a particular deal. For instance, a discounted price for a single product or service may be offered to users. If a predetermined number of the users sign up for the offer, then the deal becomes available to all of the users. If the predetermined number of the users does not sign up for the offer, the offer is retracted and is not available to any of the users.

### BRIEF SUMMARY OF THE INVENTION

Various approaches are described herein for, among other things, providing group discounts to users. In one type of group discount, a group discount package is configured by associating a plurality of different items with the package, associating a discount price with each item, and associating a threshold value with at least one of the items. In another type of group discount, a group discount package is configured by associating one or more different items with the package, associating a discount price with each item, associating one or more actions with the package, and associating a threshold value with one or more of the items and actions. The group discount package is offered to a population of users, and a deal with the package is confirmed when each associated threshold value is met.

The items include products and/or services. The actions may be any type of actions that may be performed by users and tracked, including actions performed on social networks, at other websites (e.g., charities), etc. Users that receive the offer may purchase one or more of the items included in the offer, including purchasing a number of items that is less than the total number of items included in the offer, and may perform one or more of the actions. Furthermore, the users may recommend the offer to others persons, such as by posting or recommending the offer to their friends in a social network.

In one method implementation, a group discount package is configured by associating a plurality of different items with the package, associating a discount price with each item, and associating a threshold value with at least one item associated with the package. One or more actions that have corresponding threshold values may also be associated with the package. The group discount package may be offered by enabling users to request to purchase items associated with the package. Each user may request to purchase one or more of the items associated with the package at the associated discount price. Furthermore, the users may be enabled to perform any actions associated with the package. A deal with the package is confirmed when each associated threshold value is met.

In one system implementation, a group discounting system includes a package configuration module. The package configuration module generates a user interface that enables a group discount package to be configured by a user (e.g., a seller, vendor, or merchant). The user interface is configured to enable at least one item to be associated with the package, one or more actions to be associated with the package, a discount price to be associated with each item, a threshold value to be associated with the item(s), and a threshold value to be associated with the action(s).

The group discounting system may further include a group discount offering engine. The group discount offering engine is configured to offer the group discount package to users. The group discount offering engine enables users to request to purchase one or more of the items of the package at the associated discount price. The group discount offering engine also tracks any actions performed by users. The group discount offering engine confirms a deal with the group discount package when each associated threshold value is met.

Computer program products are also described herein that enable group discount packages to be configured and offered to users, as well as enabling further embodiments described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a communication system for offering group discounts, according to an example embodiment.

FIG. 2 shows a flowchart providing a process for offering group discounts, according to an example embodiment.

FIG. 3 shows a block diagram of a group discounting system, according to an example embodiment.

FIG. 4 shows a block diagram of a server configured to enable a group discount package to be configured, according to an example embodiment.

FIG. 5 shows a block diagram of a server configured to conduct a group discount offer with a population of users, according to an example embodiment.

FIG. 6 shows a block diagram of a display at a user device used to display an offer to a corresponding user, according to an example embodiment.

FIG. 7 shows a flowchart providing a process for offering a group discount that includes a plurality of items, according to an example embodiment.

FIG. 8 shows a flowchart providing a process for offering a group discount that includes first and second items, and a threshold value associated with the first item, according to an example embodiment.

FIG. 9 shows a flowchart providing a process for offering a group discount that includes first and second items, and threshold values associated with the first and second items, according to an example embodiment.

FIG. 10 shows a flowchart providing a process for offering a group discount that includes at least one item and at least one action, according to an example embodiment.

FIG. 11 shows a block diagram of a group discount offering engine that receives an indication of an action performed at a social network, according to an example embodiment.

FIG. 12 shows a flowchart providing a process for offering a group discount that includes an item and an action, and a threshold value associated with the action, according to an example embodiment.

FIG. 13 shows a flowchart providing a process for offering a group discount that includes an item and first and second actions, and threshold values associated with the item and the first and second actions, according to an example embodiment.

FIG. 14 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Websites exist that provide coupons for discounted products and services, such as groupon.com and livingsocial.com. Some of these websites provide coupons that are activated if a predetermined minimum number of persons sign up for a particular deal (e.g., a “Groupon®”). For instance, a company may offer a discounted price for a single product or service to users. The offer may be made to the users by email or by other communication. If a predetermined number of the users sign up for the offer, then the deal becomes available to all of the users. If the predetermined number of the users does not sign up for the offer, the offer is retracted from all of the users.

However, such techniques for providing coupons have limitations, such as being limited to a single product or service. Furthermore, such techniques do not incorporate actions that may be tracked and required to be performed to enable a deal to be confirmed.

In embodiments, improved techniques are provided for online shopping using coupons, discounts, and further types of commercial incentives. In an embodiment, an online shopping system is provided that enables a group of users to buy multiple items with a specified discount if one or more thresholds are met. As described above, current shopping/sales techniques involve (a) a single user that buys a single product or service (a traditional purchase), (b) a single user that buys multiple products/services together (a combo deal), and (c) a group of users that buy a same product or service (a Groupon®). Embodiments provide improvements over such shopping techniques, such that groups of users are incentivized and enabled to purchase multiple different items at in a same offer.

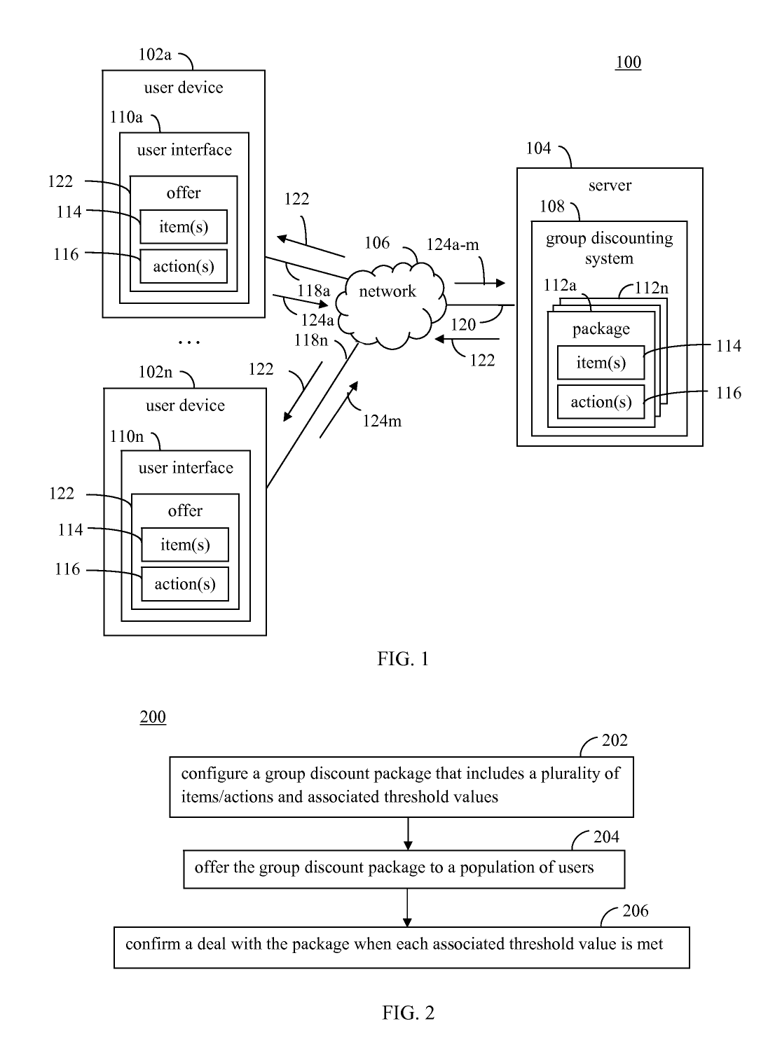

Such embodiments may be implemented in a variety of environments. For instance, FIG. 1 shows a block diagram of a communication system 100 in which group discounts may be offered, according to an example embodiment. Environment 100 is shown for purposes of illustration, and embodiments may be implemented in other environments, as would be apparent to persons skilled in the relevant art(s) from the teachings herein. As shown in FIG. 1, system 100 includes first-nth user devices 102a-102n, a server 104, and network 106. Furthermore, server 104 includes a group discounting system 108. System 100 is described as follows.

User devices 102a-102n may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device. Server 104 may be implemented in one or more computer systems, including one or more servers, which may be any type of computing device described herein or otherwise known that is capable of enabling the corresponding functionality described herein.

User devices 102a-102n and server 104 are communicatively coupled with each other through network 106. Network 106 may be a LAN (local area network), a WAN (wide area network), or any combination of networks, such as the Internet. User devices 102a-102n are each coupled with network 106 through a corresponding one of communication links 118a-118n, and server 104 is coupled with network 106 by communication link 120. Communication links 118a-118n and 120 may each include wired and/or wireless links. Examples of communication links 118a-118n and 120 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Group discounting system 108 is configured to enable group discounts based upon multiple products and/or services (“items”) to be offered to groups of users. For example, as shown in FIG. 1, group discounting system 108 may enable a plurality of group discount packages 112a-112n to be configured by corresponding entities (e.g., by individuals, by companies, etc.). Each of group discount packages 112a-112n indicates one or more items 114 on sale with discounted prices. Furthermore, threshold values may be associated in packages 112a-112n with one or more of items 114. For instance, each item 114 may have an associated minimum purchase quantity. Each threshold value for an item 114 of a package has to be met for an offer of the package to be confirmed (e.g., a number of users that meets or exceeds the associated minimum purchase quantity must request to purchase an item).

Furthermore, group discount packages 112a-112n may optionally indicate one or more actions 116 to be performed. Actions 116 may be any actions that may be performed by users and tracked. For instance, examples of actions 116 include charitable donations, “like” indications (e.g., performed on a social network and/or other websites to indicate a person, product, or service is liked), “follow” indications (e.g., performed on a social network such as Twitter® operated by Twitter, Inc. of San Francisco, Calif.) to enable a user to receive text messages from an entity, friend requests (e.g., performed on social networks) to include an entity in a user's friends list, etc. Examples of social networks include Facebook® operated by Facebook, Inc. of Palo Alto, Calif., Google+ operated by Google, Inc. of Mountain View, Calif., etc. Threshold values may be associated in packages 112a-112n with each action 116. For instance, each action 116 may have an associated minimum performance number. The threshold value for each action 116 of a package 112 has to be met for an offer of the package to be confirmed (e.g., a number of users that exceeds the associated minimum performance number must perform the action).

Group discounting system 108 at server 104 may transmit an offer for a group discount package to users. For instance, an offer 122 that is an offer for group discount package 112a is shown being transmitted to users in FIG. 1. Offer 122 may be transmitted in one or more communication signals through network 106 to users at user devices 102a-102n. Offer 122 may be transmitted in an email message, in a text message, in a “tweet” (e.g., provided by Twitter, Inc. of San Francisco, Calif.), in a social network message, in a web page, in a message displayed by an application (e.g., by an application executing in a desktop computer, a web application hosted in a browser, an “app” at a mobile device, etc.), or in another manner.

As shown in FIG. 1, offer 122 is received for display to users at user devices 102a-102n. Users of user devices 102a-102n form a user population. For instance, the user population may include users that are members of a group discounting service (e.g., an online coupon system, etc.) associated with group discounting system 108, and/or may include users that are not members. User devices 102a-102n may each include a corresponding one of user interfaces 110a-110n that are used to provide (e.g., display) offer 122 to one or more users. For instance, user interfaces 110a-110n may each include a graphical user interface (GUI), such as a user interface provided by an email tool, by an application, by a web browser, etc. User interfaces 110a-110n enable offer 122 to be displayed to the users of user devices 102a-102n. The display of offer 122 at user devices 102a-102n includes a display of the criteria of package 112a, including an indication of item(s) 114 that may be purchased, action(s) 116 that may be performed, threshold values, and/or further information of package 112a.

The users at user devices 102a-102n may each accept or reject offer 122. For instance, to accept offer 122, a user may offer to purchase at least one of item(s) 114 indicated in offer 122. Furthermore, if any action(s) 116 are indicated in offer 122, the user may perform one or more of the action(s) 116. As shown in FIG. 1, one or more of user devices 102a-102n may transmit a response, such as responses 124a-124m, to group discounting system 108 at server 104. The number of responses 124a-124m may be the same or different from the number of users to which offer 122 was extended. Responses 124a-124m each indicate any of item(s) 114 that a user at a corresponding one of user devices 102a-102n requested to purchase. Furthermore, responses 124a-124m may indicate any actions that the corresponding users performed, or the indications of the actions performed by users may be received from other entities over network 106 (e.g., a charity website, a social network, etc.).

Group discounting system 108 receives responses 124a-124m, and determines whether to confirm a deal with the responding users based on responses 124a-124m. For instance, group discounting system 108 may determine whether the minimum purchase number thresholds for each of item(s) 114 of offer 122 is/are met. Furthermore, if any action(s) 116 were included in offer 122, group discounting system 108 may determine whether the minimum performance number thresholds for each of action(s) 116 of offer 122 is/are met. If the thresholds are all met, group discounting system 108 may confirm the deal, and the responding users are enabled to receive any items 114 of offer 122 that they requested to purchase at the corresponding discounted purchase price(s). If the thresholds are not all met, the offer is not confirmed, and the users cannot purchase items 114 of offer 122 at the discounted price(s).

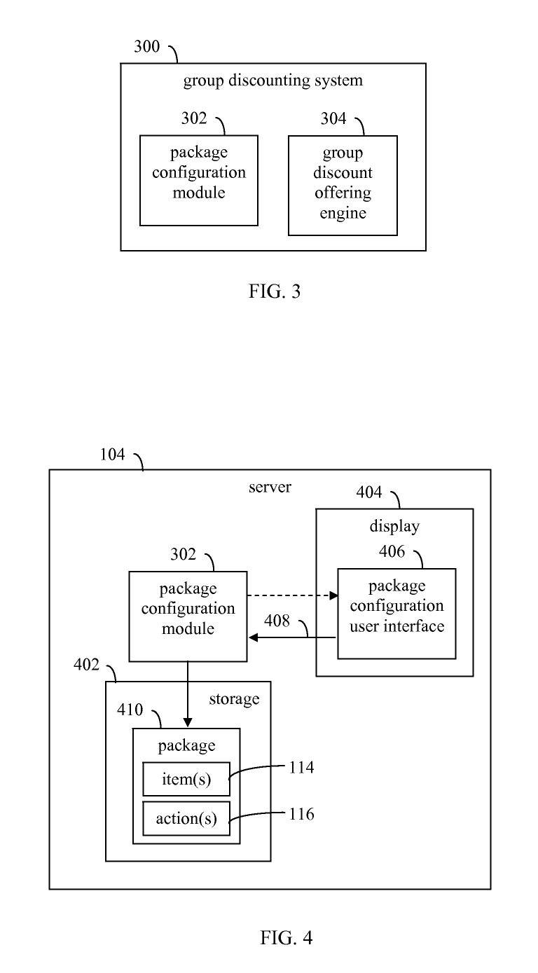

In embodiments, group discounting system 108 may operate in various ways to enable group discounts. For instance, FIG. 2 shows a flowchart 200 providing a process for offering group discounts, according to an example embodiment. In an embodiment, group discounting system 108 may operate according to flowchart 200. Furthermore, FIG. 3 shows a block diagram of a group discounting system 300, according to an example embodiment. Group discounting system 300 is an example of group discounting system 108. As shown in FIG. 3, group discounting system 300 includes a package configuration module 302 and a group discount offering engine 304. Flowchart 200 is described with respect to group discounting system 300 for illustrative purposes. Further structural and operational embodiments will be apparent to persons skilled in the relevant art(s) based on the following description of flowchart 200 and group discounting system 300.

Flowchart 200 begins with step 202. In step 202, a group discount package is configured that includes a plurality of items/actions and associated threshold values. For example, in an embodiment, package configuration module 302 may enable a user to generate a group discount package that may be offered to users. The group discount package indicates one or more items offered at discounted prices, and may optionally indicate one or more actions to be performed.

Package configuration module 302 may be implemented in various ways. For instance, FIG. 4 shows a block diagram of server 104 of FIG. 1 configured to enable a group discount package to be configured, according to an example embodiment. As shown in FIG. 4, server 104 includes package configuration module 302, storage 402, and a display 404. In an embodiment, package configuration module 302 may generate a package configuration user interface 406 that is displayed by display 404 (or by another display). User interface 406 is configured to enable a user to configure a group discount package.

For instance, a user of server 104 or of another computing device may desire to generate a group discount package. The user may provide a request to package configuration module 302 in any form (e.g., by navigating to a website hosted by package configuration module 302, by email, etc.) to generate a group discount package. Package configuration module 302 may provide user interface 406 to the user. User interface 406 may be displayed by display 404 to the user at server 104, or may be transmitted to a computing device of the user through a network (e.g., network 106 of FIG. 1), and displayed to the user at their computing device. The user may interact with user interface 406 to configure a group discount package. For instance, user interface 406 may provide one or more user interface elements, such as text entry boxes, check boxes, pull down menus, etc., that enable the user to configure the group discount package. The user may be enabled to input various package information, such as being enabled to input a name for the group discount package, an indication of one or more items that may be purchased, an indication of one or more actions that may be performed (optional), an indication of original prices for the item(s) (optional), an indication of discount prices for the item(s), an indication of any threshold values associated with the items and actions, an indication of an expiration date for an offer of the package (optional), an indication of a minimum number of the different items of the package (when multiple items are present) that a user has to purchase to take part in an offer (optional), and/or further package information. User interface 406 may be displayed in any form, such as in a browser window generated by a web browser, in a window of an application, etc.

As shown in FIG. 4, package configuration module 302 receives package configuration information 408 from user interface 406. Package configuration information 408 includes the package information input by the user for the group discount package being configured. Package configuration module 302 stores the package information in a group discount package 410 in storage 402. As shown in FIG. 4, package 410 indicates item(s) 114 and action(s) 116 (when present). Group discount package 410 may subsequently be accessed in storage 402 to be offered to users as offer 122 as described above and/or elsewhere herein.

Display 404 may be any type of display mentioned elsewhere herein or otherwise known, including an LCD (liquid crystal display), an LED (light emitting diode), a plasma display, a CRT (cathode ray tube) display, etc. Storage 402 may each include one or more of any type of storage mechanism to store resources, including a magnetic disk (e.g., in a hard disk drive), an optical disc (e.g., in an optical disk drive), a magnetic tape (e.g., in a tape drive), a memory device such as a RAM device, a ROM device, etc., and/or any other suitable type of storage medium.

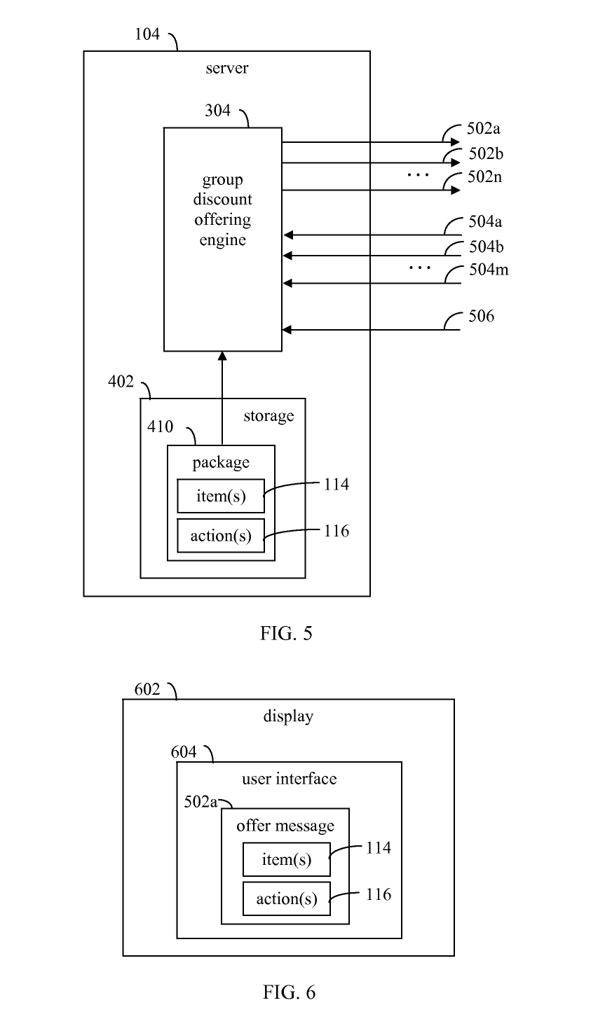

Referring back to flowchart 200 in FIG. 2, in step 204, the group discount package is offered to a population of users. For example, in an embodiment, group discount offering engine 304 of FIG. 3 may be configured to offer a group discount package to users. Group discount offering engine 304 may be implemented in various ways. For instance, FIG. 5 shows a block diagram of server 104 of FIG. 1 configured to conduct a group discount offer with a population of users, according to an example embodiment. As shown in FIG. 5, server 104 includes group discount offering engine 304 and storage 402. As shown in FIG. 5, group discount offering engine 304 may access package 410 in storage 402 (e.g., where any number of packages, such as plurality of packages 112a-112n of FIG. 1, may be stored). Group discount offering engine 304 receives package 410, and offers the group discount described in package 410 to users.

For instance, as shown in FIG. 5, group discount offering engine 304 may transmit the offer to users in one or more communications, such as first-nth offer messages 502a-502n transmitted to a corresponding number of users in a user population. Offer messages 502a-502n may be transmitted in a same way or in different ways, including being transmitted in one or more of an email message and displayed using an email tool, a text message, a “tweet”, a social network message, a web page displayed in a browser, a message displayed by an application (e.g., by an application executing in a desktop computer, a web application hosted in a browser, an “app” at a mobile device, etc.), and/or in another manner. User devices (e.g., user devices 102a-102n of FIG. 1) of the users may receive and display their respect offer message of first-nth offer messages 502a-502n so that the users may decide whether to participate.

For instance, FIG. 6 shows a block diagram of a display 602 at a user device used to display offer message 502a to a corresponding user, according to an example embodiment. As shown in FIG. 6, display 602 displays a user interface 604, which may be a textual or graphical user interface (GUI), such as a user interface provided by an email tool, by an application, by a web browser, by a text message interface, etc. User interface 604 displays offer message 502a, including displaying information associated with offer message 502a from the corresponding group discount package, such as one or more of a name, an indication of one or more items that may be purchased, an indication of one or more actions that may be performed (optional), an indication of original prices for the item(s) (optional), an indication of discount prices for the item(s), an indication of any threshold values associated with the items and actions, an indication of an expiration date (optional), an indication of a minimum number of the different items of the package (when multiple items are present) that a user has to purchase to take part in an offer (optional), and/or further offer information. A user of the user device may interact with user interface 604 to select one or more of item(s) 114 for purchase, to provide identifying information for the user (if not already known by group discounting system 300 of FIG. 3 as part of a membership, etc.), and/or to provide further information. The user may interact with user interface 604 to submit the purchase request for one or more of item(s) 114 so as to participate in offer message 502a.

For example, as shown in FIG. 5, group discount offering engine 304 may receive responses 504a-504m to offer messages 502a-502n from users in one or more communications. Responses 504a-504m may indicate that corresponding users of the population of users desired to participate in the offer, and may each indicate one or more of item(s) 114 that the corresponding user is requesting to purchase as part of the offer.

Referring back to flowchart 200 in FIG. 2, in step 206, a deal with the package is confirmed when each associated threshold value is met. In an embodiment, group discount offering engine 304 is configured to confirm a deal associated with a package when each threshold value associated with item(s) 114 and action(s) 116 (when present) of the package and corresponding offer are met.

For instance, as shown in FIG. 5, group discount offering engine 304 may determine whether a deal associated with package 410 may be confirmed. Group discount offering engine 304 may determine whether responses 504a-504m for the offer corresponding to package 410 include a number of purchase requests that meet or exceed the purchase number threshold value(s) for each of item(s) 114 of package 410. Furthermore, if package 410 includes one or more actions 116, group discount offering engine 304 may determine a number of actions were performed that meet or exceed the performance number threshold value(s) for each of action(s) 116 of package 410.

For example, as shown in FIG. 5, group discount offering engine 304 may receive an action indication 506 that indicates performance of one or more of action(s) 116 of package 410. Action indication 506 may be received from any suitable source capable of tracking whether action(s) 116 of package 410 are performed. For instance, in one example, action indication 506 may received from a social network, such as Twitter®, Facebook® Google+, or other social network. Action indication 506 may indicate numbers of action(s) 116 that were performed, such as “like” indications performed at the social network (e.g., indicating a person, product, service, company, etc. indicated in package 410 is liked), “follow” indications performed at the social network (e.g., indicating that a person, product, service, company, etc. is being followed), friend requests performed at the social networks, etc. Alternatively, action indication 506 may be received from a charity to indicate that a charitable donation was made, or may be received from another source where actions may be performed and tracked.

If all of the threshold values set for item(s) 114 in package 410 have been equaled or exceeded, and if any action(s) 116 are present in package 410 and their threshold values set in package 410 have been equaled or exceeded, group discount offering engine 304 may indicate that a deal with package 410 is confirmed. Group discount offering engine 304 may store an indication in storage 402 that the deal with package 410 is confirmed, and/or may store the confirmed indication elsewhere. Furthermore, group discount offering engine 304 may notify each user that provided one of responses 504a-504m that the deal is confirmed. Group discount offering engine 304 may notify the users in any manner, including one or more of an email, a text message, a “tweet”, an indication in a web page, an indication in a member account of each user, an indication provided by an application, an indication in user interface 604 (FIG. 6), and/or in another manner.

As such, in this manner, a new online shopping system that provides incentives to a group of users for buying multiple items and/or performing some actions is provided. In embodiments, for each transaction, the following features may be enabled:
1a. Multiple items in a promotion package, or
1b. One or more items and one or more actions in a promotional package.
2. For each item, a specific discount can be applied once the deal goes through.
3. For each item (and each action, when present), a specific threshold can be set by the seller (e.g., a minimum amount of sales of the item for the deal to be confirmed).
4. An optional expiration date/time.
5. A user can optionally advertise the deal to his/her social network.
   As such, in one embodiment, packages may be expressed as follows:
I={i₁, . . . , iₙ} represents items included in a package (n total items),
P={p₁, . . . , pₙ} are the original (non-discounted) prices,
I′={i₁, . . . , iₙ, a₁, . . . , aₖ} represents items and actions in a package (k total actions),
P′={p′₁, . . . , p′ₙ} are the new (discounted) prices of items, such that p′ᵢ≦pᵢ for 1≦i≦n, and
H={hp₁, . . . , hpₙ, ha₁, . . . , haₖ} are the deal thresholds.

In conventional online coupon systems, such as Groupon®, a single item with a single discount and a single threshold are provided. However, according to embodiments of the present invention, (a) multiple items with corresponding discounts and thresholds may be provided, or (b) one or more items with corresponding discounts and thresholds along with one or more actions with corresponding thresholds may be provided.

According to some embodiments, a deal may go through (be confirmed) if all of the package thresholds are met before the expiration time. In another embodiment, a deal may go through if one of multiple package thresholds is met, if configured in this manner by a seller.

In an embodiment, a minimum number of “T” items of a package may have to be purchased by a user to be eligible for discount pricing. “T” may have a value that is less than the number of items in the package, and in such case, a user does not have to buy all the items of the package. For instance, “T” may have a value of 1 so that a user does not have to buy multiple items of the package, when multiple items are present.

In an embodiment, a package may include user actions which do not have a price, but instead are to be performed, such as following an entity designated in the package on Twitter®, being a fan of an entity designated in the package on Facebook®, making a donation to an entity designated in the package, etc., enabling various marketing strategies.

In an embodiment, if any of the package thresholds are not met, the deal fails and no transactions with regard to the package are performed (unless some users request to purchase items according to their original, non-discounted prices).

As such, embodiments provide one or more advantages, such as relatively inexpensive item prices, which can be an incentive to boost sales; use of a social network to advertise a deal and/or to track actions, boosting the sales of the “hard-to-sell” items (by including them in a package with easier-to-sell items), and boosting user actions for marketing purposes. Note that multiple items included in a package may or may not be related to each other. For instance, a package may include a type of smart phone and a type of cover for the smart phone (related items), or may include a type of smart phone and an item of clothing (non-related items). Furthermore, as described above, a user need not necessarily have to request to purchase all of the items of a package. In some embodiments, a user may request to purchase a single item of the multiple items in a package, and still be able to participate in the offer.

Flowchart 200 (FIG. 2) and group discounting system 108 may operate in various ways, in embodiments. Example embodiments are described in further detail in the following subsections.

A. Example Group Discount Packages that Include Multiple Items

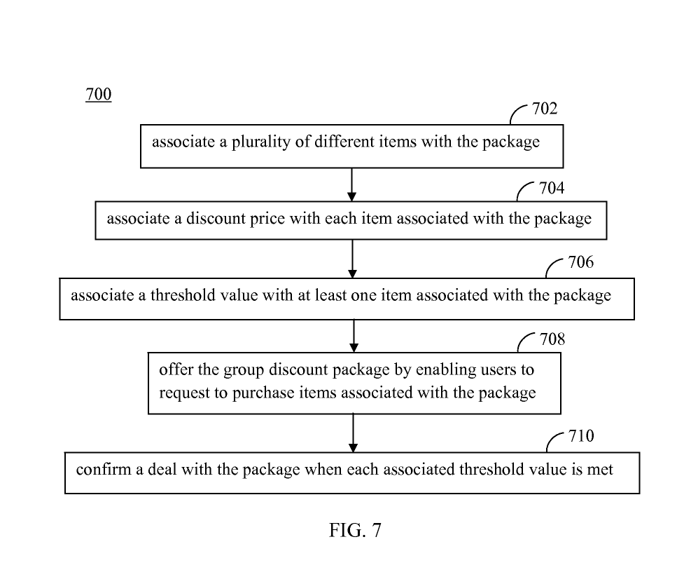

In embodiments, group discount packages may be formed that include multiple items 114 (and no actions 116). For instance, FIG. 7 shows a flowchart 700 providing a process for offering a group discount that includes a plurality of items according to an example embodiment. Flowchart 700 is an example implementation of flowchart 200 of FIG. 2 (steps 702-706 are an example of step 202 of flowchart 200). In an embodiment, group discounting system 108 (FIG. 1) and group discounting system 300 (FIG. 3) may operate according to flowchart 700. Further structural and operational embodiments will be apparent to persons skilled in the relevant art(s) based on the following description of flowchart 700.

Flowchart 700 begins with step 702. In step 702, a plurality of different items is associated with the package. For example, as described above with respect to FIG. 4, a user (e.g., a vendor, merchant, seller, etc.) may interact with package configuration user interface 406 to associate multiple items 114 with package 410.

In step 704, a discount price is associated with each item associated with the package. For instance, as described above with respect to FIG. 4, the user may interact with package configuration user interface 406 to indicate a discount price with each item in package 410. The user may optionally also indicate the original, non-discount prices for each item.

In step 706, a threshold value is associated with at least one item associated with the package. For example, as described above with respect to FIG. 4, the user may interact with package configuration user interface 406 to associate a threshold value, such as a minimum purchase number, with each item in package 410.

Note that flowchart 700 (and further flowcharts provided herein) may include further steps for configuring a package, including indicating an expiration date for an offer associated with the package, a maximum number of each item that may be sold in a deal (e.g., to prevent the seller from committing to selling higher numbers of each item than the seller is capable of), a name and/or further description associated with the package (e.g., information about the seller, marketing information, etc.), and/or further information.

In step 708, the group discount package is offered by enabling users to request to purchase items associated with the package. For example, as described above with respect to FIG. 5, group discount offering engine 304 may make an offer to users based on package 410, such as by displaying and/or transmitting offer messages 502a-502n. As a result, as described with respect to FIG. 6, users are enabled to request to purchase one or more of the items.

In step 710, a deal with the package is confirmed when each associated threshold value is met. For example, as described above with respect to FIG. 5, a deal with package 410 may be confirmed by group discount offering engine 304 when each threshold value associated with the items of package 410 are met. For instance, group discount offering engine 304 may count the number of purchase requests in responses 504a-504m for each item. If the counted number of purchase requests for each item meet or exceed the corresponding threshold value, the deal with package 410 may be confirmed.

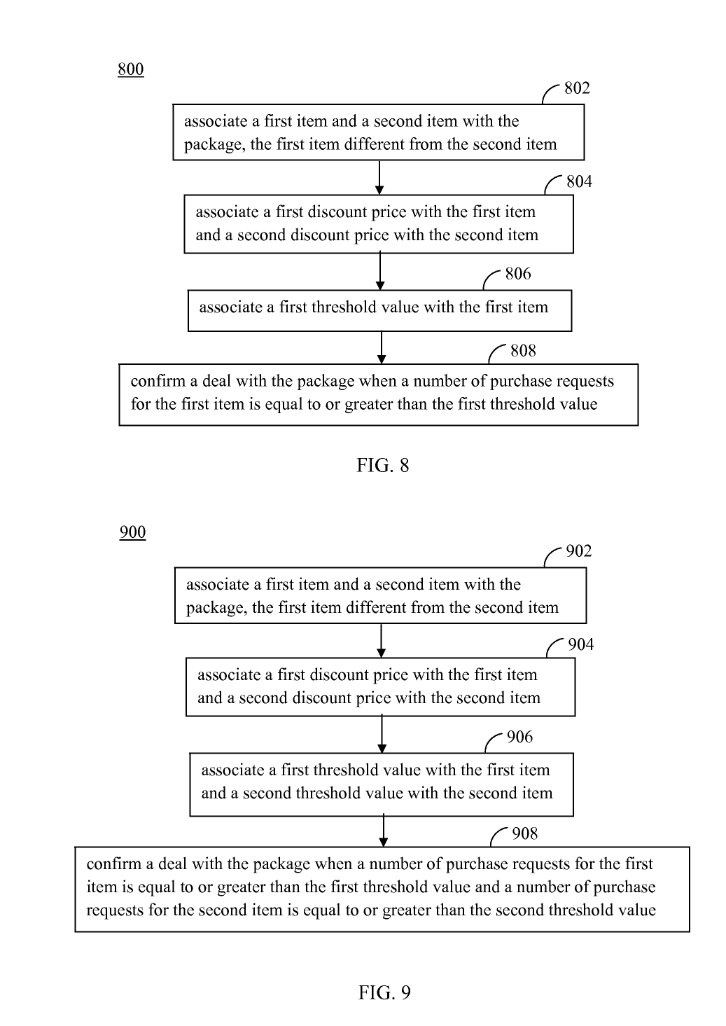

Two embodiments of flowchart 700 are described as follows with respect to FIGS. 8 and 9 for purposes of illustration. For instance, FIG. 8 shows a flowchart 800 provides a process for offering a group discount that includes first and second items, and a threshold value associated with the first item, according to an example embodiment. In an embodiment, group discounting system 108 (FIG. 1) and group discounting system 300 (FIG. 3) may operate according to flowchart 800. Further structural and operational embodiments will be apparent to persons skilled in the relevant art(s) based on the following description of flowchart 800.

Flowchart 800 begins with step 802. In step 802, a first item and a second item are associated with the package, the first item being different from the second item. For example, as described above with respect to FIG. 4, a user (e.g., a vendor, merchant, seller, etc.) may interact with package configuration user interface 406 to associate two items 114—a first item and a second item—with package 410.

In step 804, a first discount price is associated with the first item and a second discount price is associated with the second item. For instance, as described above with respect to FIG. 4, the user may interact with package configuration user interface 406 to indicate a discount price for the first item and a discount price for the second item in package 410. The user may optionally also indicate the original, non-discount prices for the first and second items.

In step 806, a first threshold value is associated with the first item. For example, as described above with respect to FIG. 4, the user may interact with package configuration user interface 406 to associate a threshold value, such as a minimum purchase number, with each item in package 410. In the example of flowchart 800, a threshold value is associated with the first item, but not with the second item.

Although not shown in FIG. 8, step 708 of flowchart 700 (FIG. 7) may be performed in flowchart 800, where the group discount package is offered by enabling users to request to purchase the first and second items associated with the package. For example, as described above with respect to FIG. 5, group discount offering engine 304 may make an offer to users based on package 410, such as by transmitting offer messages 502a-502n. As a result, as described with respect to FIG. 6, users are enabled to request to purchase one or both of the first and second items.

In step 810, a deal with the package is confirmed when a number of purchase requests for the first item is equal to or greater than the first threshold value. For example, as described above with respect to FIG. 5, a deal with package 410 may be confirmed by group discount offering engine 304 when each threshold value associated with the items of package 410 are met. In the example of flowchart 800, the first item has a threshold value (the second item does not). For instance, group discount offering engine 304 may count the number of purchase requests in responses 504a-504m for the first item. If the counted number of purchase requests for the first item meets or exceeds the corresponding threshold value, the deal with package 410 may be confirmed, and the users that submitted responses to the offer may be enabled to purchase the first and second items at their corresponding discounted prices.

An illustrative example implementation of flowchart 800 is provided as follows. A group discount package may be configured that includes two items—a smart phone and a smart phone cover. A seller of the items may set a 10% discount for the smart phone to a discount price of $180 (from an original price of $200) and a discount price for the smart phone cover of $25 (from an original price of $30). A threshold value may be set for a minimum number of smart phone covers to be sold of 1000. No threshold value is set for the smart phones (a threshold value of zero). This package may be offered to a population of users. If the users respond by requesting to purchase at least 1000 smart phone covers, the offer may be confirmed, such that the users can purchase the smart phone covers at the discount price, as well as purchasing any smart phones (at the discount price) that the users requested to purchase. This package configuration incentivizes a boosting in the sales of smart phone covers by encouraging persons to purchase the smart phone covers in order to obtain the smart phone discount price. This package configuration may be desirable in cases where some items are difficult to sell even with a large discount (e.g., smart phone covers, in this example). Embodiments enable the seller to boost the sales of such items by leveraging discounts on some other “popular” items (e.g., a smart phone).

FIG. 9 shows a flowchart 900 providing a process for offering a group discount that includes first and second items, and includes threshold values associated with both of the first and second items, according to an example embodiment. As such, flowchart 900 is different from flowchart 800 in that threshold values are associated with both of the two items. In an embodiment, group discounting system 108 (FIG. 1) and group discounting system 300 (FIG. 3) may operate according to flowchart 900. Further structural and operational embodiments will be apparent to persons skilled in the relevant art(s) based on the following description of flowchart 900.

Flowchart 900 begins with step 902. In step 902, a first item and a second item are associated with the package, the first item different from the second item. For example, as described above with respect to FIG. 4, a user (e.g., a vendor, merchant, seller, etc.) may interact with package configuration user interface 406 to associate two items 114—a first item and a second item—with package 410.

In step 904, a first discount price is associated with the first item and a second discount price is associated with the second item. For instance, as described above with respect to FIG. 4, the user may interact with package configuration user interface 406 to indicate a discount price for the first item and a discount price for the second item in package 410. The user may optionally also indicate the original, non-discount prices for the first and second items.

In step 906, a first threshold value is associated with the first item and a second threshold value is associated with the second item. For example, as described above with respect to FIG. 4, the user may interact with package configuration user interface 406 to associate a first threshold value, such as a minimum purchase number for the first item, with the first item and a second threshold value, such as a minimum purchase number for the second item, with the second item.

Although not shown in FIG. 9, step 708 of flowchart 700 (FIG. 7) may be performed in flowchart 900, where the group discount package is offered by enabling users to request to purchase the first and second items associated with the package. For example, as described above with respect to FIG. 5, group discount offering engine 304 may make an offer to users based on package 410, such as by transmitting offer messages 502a-502n. As a result, as described with respect to FIG. 6, users are enabled to request to purchase one or both of the first and second items at their discount prices.

In step 910, a deal with the package is confirmed when a number of purchase requests for the first item is equal to or greater than the first threshold value and a number of purchase requests for the second item is equal to or greater than the second threshold value. For example, as described above with respect to FIG. 5, a deal with package 410 may be confirmed by group discount offering engine 304 when each threshold value associated with the items of package 410 are met. In the example of flowchart 900, the first and second items each have threshold values. Group discount offering engine 304 may count the number of purchase requests in responses 504a-504m for the first item and for the second item. If the counted number of purchase requests for the first item meets or exceeds the first threshold value, and the counted number of purchase requests for the second item meets or exceeds the second threshold value, the deal with package 410 may be confirmed, and the users that submitted responses to the offer may be enabled to purchase the first and second items at their corresponding discounted prices.

An illustrative example implementation of flowchart 900 is provided as follows. A group discount package may be configured that includes two items—a refrigerator and a set of kitchen cabinets. A seller of the items may set a 10% discount for the refrigerator and a 15% discount for the cabinet set from their original prices. A first threshold value may be set for a minimum number of refrigerators to be sold of 50 and a second threshold value may be set for a minimum number of cabinet sets to be sold of 40. This package may be offered to a population of users. If the users respond by requesting to purchase at least 50 refrigerators and 40 cabinet sets, the offer may be confirmed, such that the users can purchase the refrigerators and cabinet sets at their discount prices. For example, a first set of 30 users may request to purchase just the refrigerator, a second set of 20 users may request to purchase just the cabinet set, and a third set of 20 users may request to purchase both the refrigerator and the cabinet set. In this manner, 50 total users have requested to purchase the refrigerator and 40 total users have requested to purchase the cabinet set, meeting both of the threshold values, and causing the deal to be confirmed.

As such, note that not all of the users may want to purchase both a refrigerator and cabinet set. In the traditional “combo” deal setting, the seller will lose those buyers who only want one or the other because users are only enabled to purchase both or neither. As such, in traditional combo deal setting, the seller will have to set two separate deals—one for the refrigerators and another one for the cabinet sets. The seller will have to hope that any users who want to purchase both products will see both deals. In contrast, in an embodiment, all potential buyers will be able to participate in a deal because both products are made separately available in the deal, and users are not required to purchase both items. Instead, a user can request to purchase either item—the refrigerator or cabinet set—or both items, to participate in the deal. Users are not required to buy both items, and because a single deal includes both items, the deal is easier to promote (compared to promoting two separate deals).

Furthermore, in an embodiment, users A and B may be friends, and one of them may have notified the other about the offered deal in a social network in which they both participate. User A may desire to purchase the refrigerator and user B may desire to purchase the cabinet set. Users A and B can both enter the deal easily without any extra effort, and have more chance of the deal being confirmed because the deal is not restricted to only users that want to buy both items. Furthermore, their friends in their social network may be notified of the deal (e.g., by being displayed in their user feeds, etc.). As such, embodiments enable the influence of social networks to be more effective than according to traditional selling techniques.

B. Example Group Discount Packages that Include Items and Actions

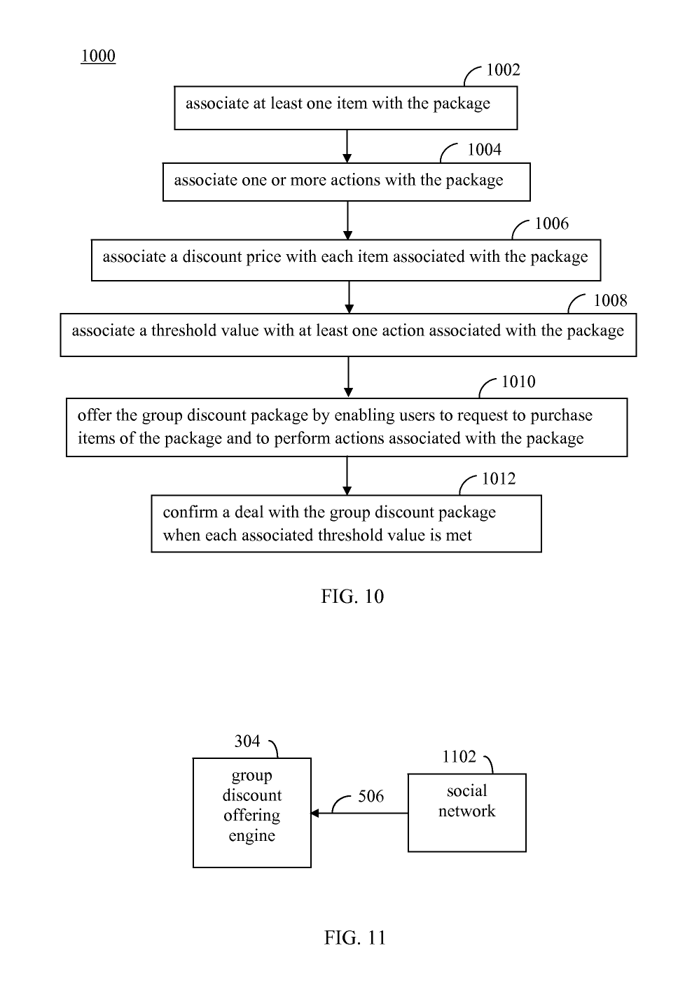

In embodiments, group discount packages may be formed that include one or more items 114 and one or more actions 116. For instance, FIG. 10 shows a flowchart 1000 providing a process for offering a group discount that includes at least one item and at least one action, according to an example embodiment. Flowchart 1000 is an example implementation of flowchart 200 of FIG. 2 (steps 1002-1008 are an example of step 202 of flowchart 200). In an embodiment, group discounting system 108 (FIG. 1) and group discounting system 300 (FIG. 3) may operate according to flowchart 1000. Further structural and operational embodiments will be apparent to persons skilled in the relevant art(s) based on the following description of flowchart 1000.

Flowchart 1000 begins with step 1002. In step 1002, at least one item is associated with the package. For example, as described above with respect to FIG. 4, a user (e.g., a vendor, merchant, seller, etc.) may interact with package configuration user interface 406 to associate one or more items 114 with package 410.

In step 1004, one or more actions are associated with the package. For example, as described above with respect to FIG. 4, the user may interact with package configuration user interface 406 to associate one or more actions 116 with package 410.

In step 1006, a discount price is associated with each item associated with the package. For instance, as described above with respect to FIG. 4, the user may interact with package configuration user interface 406 to indicate a discount price with each item in package 410. The user may optionally also indicate the original, non-discount prices for each item.

In step 1008, a threshold value is associated with at least one action associated with the package. For example, as described above with respect to FIG. 4, the user may interact with package configuration user interface 406 to associate a threshold value, such as a minimum performance number, with each action in package 410.

Furthermore, although not shown in FIG. 10, flowchart 1000 may include the step of associating a threshold value with at least one item associated with the package (e.g., similar to step 706 of FIG. 7).

In step 1010, the group discount package is offered by enabling users to request to purchase items associated with the package and to perform actions associated with the package. For example, as described above with respect to FIG. 5, group discount offering engine 304 may make an offer to users based on package 410, such as by transmitting offer messages 502a-502n. As a result, as described with respect to FIG. 6, users are enabled to request to purchase one or more of the items. Furthermore, the users may be enabled to perform actions associated with the package (e.g., making donations at charity websites, providing “like” indications, providing “follow” indications, providing friend requests, etc.).

In step 1012, a deal with the package is confirmed when each associated threshold value is met. For example, as described above with respect to FIG. 5, a deal with package 410 may be confirmed by group discount offering engine 304 when each threshold value associated with the items and actions of package 410 are met. In an embodiment, group discount offering engine 304 may count the number of purchase requests in responses 504a-504m for each item, and may count the actions performed as indicated by action indication 506. If the counted number of purchase requests for each item meet or exceed the corresponding threshold value, and the counted number of actions performed for each action meet or exceed the corresponding threshold value, the deal with package 410 may be confirmed.

For instance, FIG. 11 shows a block diagram of group discount offering engine 304 receiving an action indication 506 from a social network 1102, according to an example embodiment. Social network 1102 may be implemented in one or more servers or other computing devices, and may be implemented in a same computing device as group discount offering engine 304, or may communicate with group discount offering engine 304 over a network (e.g., network 106 of FIG. 1). When a group discount package is offered in step 1010, social network 1102 may be informed, and may be configured to track one or more actions associated with the group discount package. This may include displaying the group discount offering in an advertisement to users on the social network, or displaying the group discount offer as a deal on the social network. Furthermore, this may include enabling the group discount offer, one or more of the items, an indication of the seller, an indication of a charity listed in the package, and/or other entity to be displayed as an object in user feeds of the social network, etc. Furthermore, the social network may enable the displayed advertisement, deal, object, etc., to be interacted with by users. The users may be enabled to “like” (e.g., interact with a “like” button), to “follow”, to “friend”, to recommend, to make a donation, and/or to interact with the advertisement, deal, object, etc., in another manner to cause an action to be performed. Any such actions that are performed may be counted and indicated to group discount offering engine 304 by social network 1102 in an action indication 506.

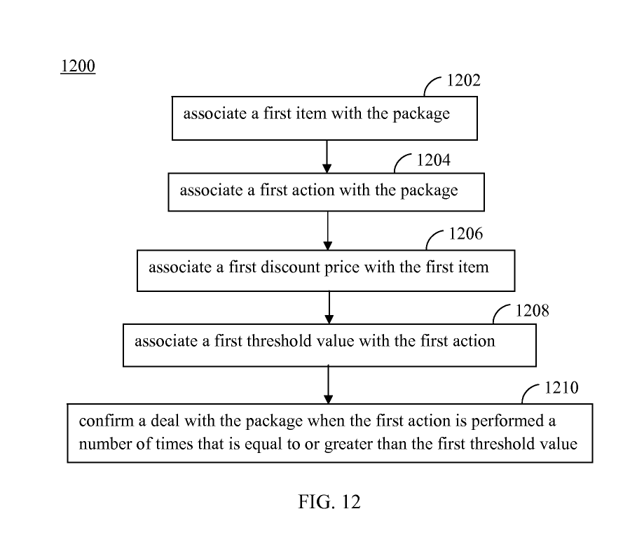

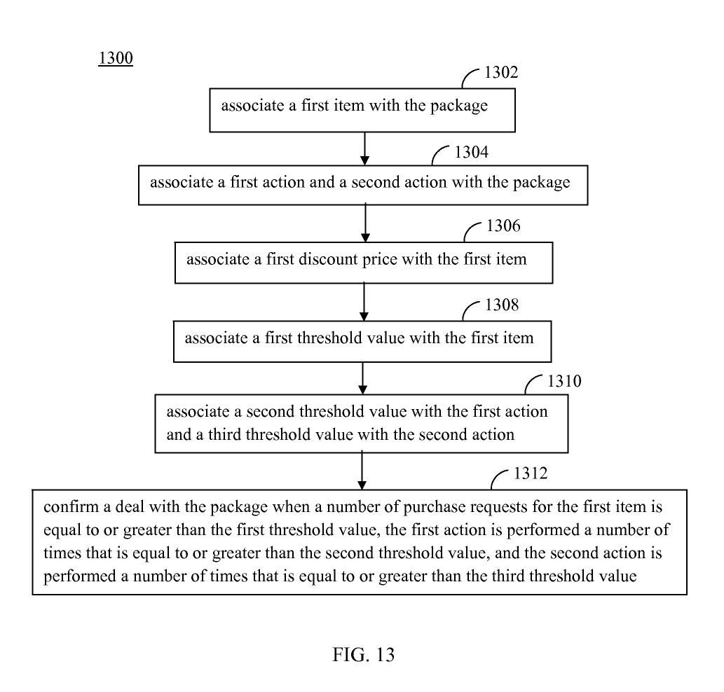

Two embodiments of flowchart 1000 are described as follows with respect to FIGS. 12 and 13 for purposes of illustration. For instance, FIG. 12 shows a flowchart 1200 providing a process for offering a group discount that includes an item and an action, and a threshold value associated with the action, according to an example embodiment. In an embodiment, group discounting system 108 (FIG. 1) and group discounting system 300 (FIG. 3) may operate according to flowchart 1200. Further structural and operational embodiments will be apparent to persons skilled in the relevant art(s) based on the following description of flowchart 1200.

Flowchart 1200 begins with step 1202. In step 1202, a first item is associated with the package. For example, as described above with respect to FIG. 4, a user may interact with package configuration user interface 406 to associate an item 114—a first item—with package 410.

In step 1204, a first action is associated with the package. For example, as described above with respect to FIG. 4, the user may interact with package configuration user interface 406 to associate an action 116—a first action—with package 410.

In step 1206, a first discount price is associated with the first item. For instance, as described above with respect to FIG. 4, the user may interact with package configuration user interface 406 to indicate a discount price for the first item in package 410. The user may optionally also indicate the original, non-discount price for the first item.

In step 1208, a first threshold value is associated with the first action. For example, as described above with respect to FIG. 4, the user may interact with package configuration user interface 406 to associate a threshold value, such as a minimum performance number, with the first action in package 410.

Although not shown in FIG. 12, step 1010 of flowchart 1000 (FIG. 10) may be performed in flowchart 1200, where the group discount package is offered by enabling users to request to purchase the first item and to perform the first action associated with the package. For example, as described above with respect to FIG. 5, group discount offering engine 304 may make an offer to users based on package 410, such as by transmitting offer messages 502a-502n. As a result, as described with respect to FIG. 6, users are enabled to request to purchase the first item. Furthermore, the users may be enabled to perform the first action associated with the package (e.g., making donations at charity websites, providing “like” indications, providing “follow” indications, providing friend requests, etc.).

In step 1210, a deal with the package is confirmed when the first action is performed a number of times that is equal to or greater than the first threshold value. For example, as described above with respect to FIG. 5, a deal with package 410 may be confirmed by group discount offering engine 304 when the threshold value associated with first action of package 410 is met (no threshold values for items are present in package 410, in this example). For instance, group discount offering engine 304 may count the number of times the first action is performed as indicated by action indication 506. If the counted number of actions performed for the first action meets or exceeds the corresponding threshold value, the deal with package 410 may be confirmed.

An illustrative example implementation of flowchart 1200 is provided as follows. A group discount package may be configured that includes one item and one action—a meal deal and a $1 donation. A seller of the items may set a 25% discount for the meal deal to a discount price of $6 (from an original price of $8). A threshold value may be set for a minimum number of donation actions of 10,000. For instance, a charity website, a social network, or other entity may be configured with a $1 donation “button” or other user interface element to enable the donations to be made. No threshold value is set for the meal deal (a threshold value of zero). This package may be offered to a population of users. If the users respond by performing actions such that 10,000 donations of $1 are made, the offer may be confirmed, such that the users can purchase the meal deal at the discount price. This package configuration incentivizes donations to be made, and may enable friends of users to be asked to make the donation (e.g., by displaying the donation option as an object in a user's feed in a social network when the user makes a donation, etc.). Furthermore, the seller is enabled to promote the donation, and improve its reputation, while also promoting sales of the meal deal.

FIG. 13 shows a flowchart 1300 providing a process for offering a group discount that includes an item and first and second actions, and threshold values associated with each of the item and the first and second actions, according to an example embodiment. In an embodiment, group discounting system 108 (FIG. 1) and group discounting system 300 (FIG. 3) may operate according to flowchart 1300. Further structural and operational embodiments will be apparent to persons skilled in the relevant art(s) based on the following description of flowchart 1300.

Flowchart 1300 begins with step 1302. In step 1302, a first item is associated with the package. For example, as described above with respect to FIG. 4, a user may interact with package configuration user interface 406 to associate an item 114—a first item—with package 410.

In step 1304, a first action and a second item are associated with the package. For example, as described above with respect to FIG. 4, the user may interact with package configuration user interface 406 to associate two actions 116—a first action and a second action—with package 410.

In step 1306, a first discount price is associated with the first item. For instance, as described above with respect to FIG. 4, the user may interact with package configuration user interface 406 to indicate a discount price for the first item in package 410. The user may optionally also indicate the original, non-discount price for the first item.

In step 1308 a first threshold value is associated with the first item. For example, as described above with respect to FIG. 4, the user may interact with package configuration user interface 406 to associate a threshold value, such as a minimum purchase number, with the first item in package 410.

In step 1310, a second threshold value is associated with the first action and a third threshold value is associated with the second action. For example, as described above with respect to FIG. 4, the user may interact with package configuration user interface 406 to associate a threshold value, such as a minimum performance number, with the first action in package 410, and to associate a threshold value with the second action in package 410.

Although not shown in FIG. 13, step 1010 of flowchart 1000 (FIG. 10) may be performed in flowchart 1300, where the group discount package is offered by enabling users to request to purchase the first item and to perform the first and second actions associated with the package. For example, as described above with respect to FIG. 5, group discount offering engine 304 may make an offer to users based on package 410, such as by transmitting offer messages 502a-502n. As a result, as described with respect to FIG. 6, users are enabled to request to purchase the first item. Furthermore, the users may be enabled to perform the first and second actions associated with the package (e.g., making donations at charity websites, providing “like” indications, providing “follow” indications, providing friend requests, etc.).

In step 1312, a deal with the package is confirmed when a number of purchase requests for the first item is equal to or greater than the first threshold value, the first action is performed a number of times that is equal to or greater than the second threshold value, and the second action is performed a number of times that is equal to or greater than the third threshold value. For example, as described above with respect to FIG. 5, a deal with package 410 may be confirmed by group discount offering engine 304 when the threshold value associated with the first item of package 410 is met, the threshold value with the first action of package 410 is met, and the threshold value with the second action of package 410 is met. For instance, group discount offering engine 304 may count the number of purchase requests in responses 504a-504m for the first item, and may count the number of the first and second actions performed as indicated by action indication 506. If the counted number of purchase requests for the first item meets or exceeds the corresponding threshold value, and the counted number of actions performed for each of the first and second actions meet or exceed their corresponding threshold values, the deal with package 410 may be confirmed.

An illustrative example implementation of flowchart 1300 is provided as follows. A group discount package may be configured that includes one item and two actions—a meal special provided by a restaurant, a first action of providing a “like” of the restaurant on Facebook®, and a second action of providing a “follow” of the restaurant on Twitter®. The restaurant may set a 50% discount for the meal special to a discount price of $20 (from an original price of $40). A threshold value may be set for a minimum number of requests to purchase the meal special of 100, a threshold value may be set for a minimum number of “like” actions for the restaurant at Facebook® of 1000, and a threshold value may be set for a minimum number of “follow” actions for the restaurant at Twitter® of 1000. For instance, Facebook® and Twitter® may be configured with a “like” “button” and a “follow” button (or other user interface element), respectively, to enable the actions to be performed. This package may be offered to a population of users. If the users respond such that at least 100 of the meal specials are requested to be purchased, at least 1000 “like” actions are performed, and at least 1000 “follow” actions are performed, the offer may be confirmed, such that the users can purchase the meal special at the discount price. This package configuration enables the restaurant to attract more customers, to sell more meal specials, and to increase its social influence and user loyalty.

Note that the above illustrative examples are provided for purposes of illustration, and are not intended to be limiting. Embodiments may be implemented with any number and different types of items, and any number of different types of actions, as would be apparent to persons skilled in the relevant art(s) from the teachings herein.

### II. Example Computer Implementations

Group discounting system 108, group discounting system 300, package configuration module 302, group discount offering engine 304, flowchart 200, flowchart 700, flowchart 800, flowchart 900, flowchart 1000, flowchart 1200, flowchart 1300, and/or any further systems, sub-systems, and/or components disclosed herein may be implemented in hardware, software, firmware, or any combination thereof. For example, group discounting system 108, group discounting system 300, package configuration module 302, group discount offering engine 304, flowchart 200, flowchart 700, flowchart 800, flowchart 900, flowchart 1000, flowchart 1200, and/or flowchart 1300 may be implemented as computer program code configured to be executed in one or more processors. Alternatively, group discounting system 108, group discounting system 300, package configuration module 302, group discount offering engine 304, flowchart 200, flowchart 700, flowchart 800, flowchart 900, flowchart 1000, flowchart 1200, and/or flowchart 1300 may be implemented as hardware logic/electrical circuitry.

As described above, group discounting systems may generate one or more user interfaces. For instance, group discounting systems may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

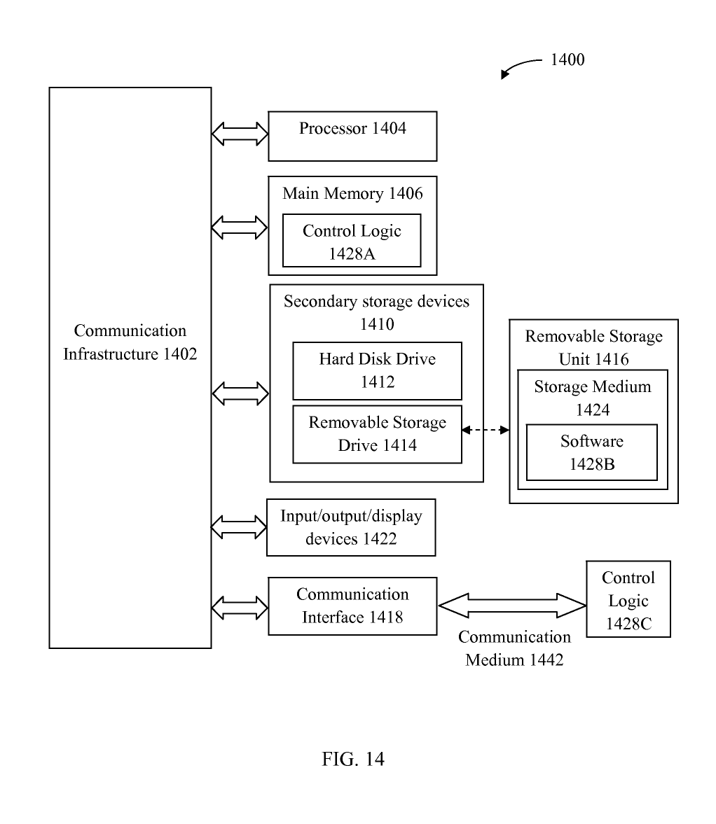

The embodiments described herein, including systems, methods/processes, and/or apparatuses, may be implemented using well known servers/computers, such as a computer 1400 shown in FIG. 14. For example, user devices 102a-102n, server 104, and any of the sub-systems or components contained therein may be implemented using one or more computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

Computer 1400 includes one or more processors (also called central processing units, or CPUs), such as a processor 1404. Processor 1404 is connected to a communication infrastructure 1402, such as a communication bus. In some embodiments, processor 1404 can simultaneously operate multiple computing threads.

Computer 1400 also includes a primary or main memory 1406, such as random access memory (RAM). Main memory 1406 has stored therein control logic 1428A (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1424 having stored therein computer software 1428B (control logic) and/or data. Removable storage unit 1416 represents a floppy disk, magnetic tape, compact disk, DVD, optical storage disk, or any other computer data storage device. Removable storage drive 1414 reads from and/or writes to removable storage unit 1416 in a well known manner.

Computer 1400 also includes input/output/display devices 1422, such as monitors, keyboards, pointing devices, etc.

Computer 1400 further includes a communication or network interface 1418. Communication interface 1418 enables computer 1400 to communicate with remote devices. For example, communication interface 1418 allows computer 1400 to communicate over communication networks or mediums 1442 (representing a form of a computer useable or readable medium), such as LANs, WANs, the Internet, etc. Network interface 1418 may interface with remote sites or networks via wired or wireless connections.

Control logic 1428C may be transmitted to and from computer 1400 via the communication medium 1442.

Any apparatus or manufacture comprising a computer useable or readable medium having control logic (software) stored therein is referred to herein as a computer program product or program storage device. This includes, but is not limited to, computer 1400, main memory 1406, secondary storage devices 1410, and removable storage unit 1416. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing group discounting system 108, group discounting system 300, package configuration module 302, group discount offering engine 304, flowchart 200, flowchart 700, flowchart 800, flowchart 900, flowchart 1000, flowchart 1200, and/or flowchart 1300 (including any step of flowcharts 200, 700, 800, 900, 1000, 1200, and 1300), and/or further embodiments described herein. Embodiments of the invention are directed to computer program products comprising such logic (e.g., in the form of program code or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention can work with software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
configuring a group discount package, including
associating a plurality of different items with the package,
associating a discount price with each item associated with the package, and
associating a threshold value with at least one item associated with the package;
offering the group discount package by enabling users to request to purchase items associated with the package, including enabling each user to request to purchase one or more of the items associated with the package at the associated discount price; and
confirming a deal with the package when each associated threshold value is met prior to a predetermined expiration time.

2. The method of claim 1, wherein the requested purchases are made when the deal is confirmed.

3. The method of claim 1, wherein said associating a plurality of different items with the package comprises:
associating a first item and a second item with the package, the first item different from the second item;
wherein said associating a discount price with each item associated with the package comprises:
associating a first discount price with the first item and a second discount price with the second item;
wherein said associating a threshold value with at least one item associated with the package comprises:
associating a first threshold value with the first item; and
wherein said confirming a deal with the package when each associated threshold value is met comprises:
confirming a deal with the package when a number of purchase requests for the first item is equal to or greater than the first threshold value.

4. The method of claim 1, wherein said associating a plurality of different items with the package comprises:
associating a first item and a second item with the package, the first item different from the second item;
wherein said associating a discount price with each item associated with the package comprises:
associating a first discount price with the first item and a second discount price with the second item;
wherein said associating a threshold value with at least one item associated with the package comprises:
associating a first threshold value with the first item and a second threshold value with the second item; and
wherein said confirming a deal with the package when each associated threshold value is met comprises:
confirming a deal with the package when a number of purchase requests for the first item is equal to or greater than the first threshold value and a number of purchase requests for the second item is equal to or greater than the second threshold value.

5. The method of claim 4, wherein said enabling each user to request to purchase one or more of the items associated with the package at the associated discount price comprises:
providing a user interface that enables a user to request to purchase only the first item, to request to purchase only the second item, and to request to purchase both the first item and the second item.

6. The method of claim 1, wherein said confirming a deal with the package when each associated threshold value is met comprises:
confirming a deal with the package when each associated threshold value is met prior to expiration of a predetermined time period; and
canceling the offer if the predetermined time period expires prior to each associated threshold value being met.

7. The method of claim 1, wherein offering the group discount package comprises:
advertising the group discount package in a social network.

8. A method, comprising:
configuring a group discount package, including
associating at least one item with the package,
associating one or more actions with the package,
associating a discount price with each item associated with the package, and
associating a threshold value with at least one action associated with the package;
offering the group discount package by enabling users to request to purchase items of the package, including enabling each user to request to purchase one or more of the items of the package at the associated discount price; and
confirming a deal with the group discount package when each associated threshold value is met prior to a predetermined expiration time.

9. The method of claim 8, wherein the requested purchases are made when the deal is confirmed.

10. The method of claim 8, wherein said associating at least one item with the package comprises:
associating a first item with the package;
wherein said associating one or more actions with the package comprises:
associating a first action with the package;
wherein said associating a discount price with each item associated with the package comprises:
associating a first discount price with the first item;
wherein said associating a threshold value with at least one action associated with the package comprises:
associating a first threshold value with the first action; and
wherein said confirming a deal with the package when each associated threshold value is met comprises:
confirming a deal with the package when a number of purchase requests for the first item is equal to or greater than the first threshold value, the first action is performed a number of times that is equal to or greater than the second threshold value, and the second action is performed a number of times that is equal to or greater than the third threshold value.

11. The method of claim 8, wherein said configuring a group discount package further comprises:
associating a threshold value with at least one item associated with the package;
wherein said confirming a deal with the group discount package when each associated threshold value is met comprises
confirming the deal with the group discount package when each threshold value associated with at least one action is met and each threshold value associated with at least one item is met.

12. The method of claim 11, wherein said associating at least one item with the package comprises:
associating a first item with the package;
wherein said associating one or more actions with the package comprises:
associating a first action and a second action with the package, the first action different from the second action;
wherein said associating a discount price with each item associated with the package comprises:
associating a first discount price with the first item;
wherein said associating a threshold value with at least one item associated with the package comprises:
associating a first threshold value with the first item;
wherein said associating a threshold value with at least one action associated with the package comprises:
associating a second threshold value with the first action and a third threshold value with the second action; and
wherein said confirming a deal with the package when each associated threshold value is met comprises:
confirming a deal with the package when the first action is performed a number of times that is equal to or greater than the first threshold value and the second action is performed a number of times that is equal to or greater than the second threshold value.

13. The method of claim 8, wherein offering the group discount package comprises:
advertising the group discount package in a social network.

14. The method of claim 8, wherein said associating at least one item with the package comprises:
associating at least a first item with the package; and
wherein said associating one or more actions with the package comprises:
associating at least a first action with the package, the first action being a donation, a like indication associated with the first item, a follow indication associated with the first item, or a friend request associated with the first item.

15. The method of claim 8, wherein said confirming a deal with the package when each associated threshold value is met comprises:
confirming a deal with the package when each associated threshold value is met prior to expiration of a predetermined time period; and
canceling the offer if the predetermined time period expires prior to each associated threshold value being met.

16. A system, comprising:
a package configuration module that generates a user interface that enables a group discount package to be configured, the user interface configured to enable at least one item to be associated with the package, one or more actions to be associated with the package, a discount price to be associated with each item associated with the package, and a threshold value to be associated with at least one action associated with the package.

17. The method of claim 16, wherein the user interface is further configured to enable a threshold value to be associated with at least one item associated with the package.

18. The system of claim 16, further comprising:
a group discount offering engine configured to offer the group discount package, the group discount offering engine configured to enable users to each request to purchase one or more of the items of the package at the associated discount price; and
wherein the group discount offering engine confirms a deal with the group discount package when each associated threshold value is met prior to a predetermined expiration time.

19. The system of claim 18, wherein the group discount offering engine is configured to email an indication of the group discount package to a member user population.
